(19) United States
(12) Patent Application Publication
(10) Pub. No.: US 2006/0270058 A1
(43) Pub. Date: Nov. 30, 2006

(54) METHOD FOR COLLECTING, EXTRACTING AND QUANTIFYING DRUGS FROM SALIVA SAMPLES AND SURFACES

(75) Inventors: JERRY DAVIS, BOISE, ID (US); RANDY REAGAN, NORFOLK, VA (US)

Correspondence Address: DYKAS, SHAVER & NIPPER, LLP, P.O. BOX 877, BOISE, ID, 83701-0877, US

(73) Assignee: UNITED DRUG TESTING LAB INC., BOISE, ID (US)

(21) Appl. No.: 11/381,177

(22) Filed: May 2, 2006

Related U.S. Application Data
(60) Provisional application No. 60/686,285, filed on May 31, 2005.
(60) Provisional application No. 60/720,243, filed on Sep. 23, 2005.

(51) Int. Cl. G01N 1/00

(52) U.S. Cl. 436/174

(57) ABSTRACT

A method for determining the presence and quantity of drugs of abuse from a surface or saliva specimen. The method involves a process of collecting the sample, preparing the sample and analyzing the sample upon an automated chemistry analyzer utilizing particular wavelengths and reagents.

### CROSS-REFERENCE TO RELATED APPLICATIONS

This application claims the priority date of the provisional application entitled METHOD FOR COLLECTING AND EXTRACTING SAMPLES SUITABLE FOR QUANTITATIVE DRUG ANALYSIS filed by Jerry Davis, et al., on May 31, 2005 with application Ser. No. 60/686,285. This application also claims priority from the provisional application entitled ADAPTIVE SAMPLE PROBE FOR AUTOMATED CHEMISTRY ANALYZERS filed by Randy R. Reagan, on Sep. 23, 2005 with application Ser. No. 60/720,243. The contents of both of these applications are herein incorporated by reference.

### FIELD OF THE INVENTION

The present invention generally relates to methods for obtaining, preparing and quantifying samples for drug testing analysis, and more particularly to a method for obtaining, preparing and quantifying levels of drugs of abuse from oral specimens and from surfaces which have been wiped with a swab.

### BACKGROUND OF THE INVENTION

The need to actively test individuals and locations for the presence of illicit drugs, drugs of abuse and their metabolites is ongoing and increasing. The use of drugs has been implicated in a variety of illegal activities and is a major factor in many of the societal ills that plague nations and societies across the world. The use of illicit drugs and drugs of abuse crosses racial, geographic and socio-economic barriers. In order to adequately treat persons who use and abuse these drugs, as well as to protect the private individual interests of other parties from the possible side effects and associations of persons who utilize these drugs, testing for the presence of these drugs has become more and more widespread.

As the frequency and availability of various tests for these drugs has increased, so too have the various methods for avoiding and limiting the efficacy of these tests. One of the factors associated with the ability of parties to cheat or attempt to cheat these testing procedures is that many of the testing procedures typically utilized in common practice, require substantial invasion of the privacy of the person being tested. For example, many times testing is done from a sample of blood or urine that must be obtained from the person being tested. The person required to collect the sample must respect the privacy of the person required to fill the urine cup, but must also take measures to ensure that the specimen that is provided is not tampered with or otherwise compromised. This may result in the person taking the sample having to shut off water, put dye in a toilet, prevent the party being tested from taking anything into the bathroom with them, and undertake other actions so as to attempt to collect an allowable sample. Furthermore, in instances where persons are unfamiliar with how to collect the sample, many times a party being tested gives the sample collector an over-filled, urine soaked cup.

Collecting blood samples is time consuming and provides increased risks to both the phlebotomist who collects the sample, as well as the party whose blood is being collected. In addition, the use of needles and other blood collecting equipment brings increased risk of accidental exposure of a variety of blood borne diseases as well as incidental injury from needle sticks.

Saliva samples are much less obtrusive to obtain than either urine or blood samples, however, the quantity of saliva that can be obtained and tested is typically significantly much less than can be obtained through a blood or urine sample. In addition, many saliva test collection methods are simply too easily contaminated. In the prior art, the method for obtaining oral (saliva) specimens for testing was simply to encourage an individual to spit or drool a sufficient amount of material so as to fill a cup or receptacle with a desired amount of saliva. This method is very time consuming and was rife with problems in sample quality, as the specimens could many times be contaminated with mucous, food and other contaminants.

In addition to the various problems associated with the collection of appropriate specimens, various problems with the testing procedures also take place. Nearly all of the most readily available screening and testing procedures that exist in the prior art, involve the use of drugs of abuse panels, which merely test for the presence of various drugs, but do not test for the quantity/semi-quantity of drugs that are present in a designated sample. The actual determination of the quantity/semi-quantity of drugs that are present in a sample had to be tested in various and more difficult and time consuming methodologies such as gas chromatography and other time consuming methods. These methods are not only time consuming, but they are also costly and are not routinely performed.

What is needed therefore is a method for collecting samples for quantitative drugs of abuse testing that is easier and less invasive than the other methods that are available in the prior art. What is also needed is a method and system for measuring the quantity of drugs of abuse in such a sample. What is also needed is a method for performing such a collection and analysis of this material that can be utilized with a broad variety of samples of various volumes.

### SUMMARY OF THE INVENTION

The present invention is a system and method for collecting samples for drug testing analysis as well as a method for testing these samples so as to obtain accurate reliable results that reflect the quantitative/semi-quantitative amounts of various drugs of abuse within these samples. The preferred embodiment of the invention which will be discussed below, includes a system and method for extracting, obtaining, collecting, preparing and analyzing oral saliva samples for appropriate quantitative /semi-quantitative levels of drugs of abuse. However, it must be specifically understood that the same principals described in the present extraction methods can also be utilized for the quantitative/semi-quantitative sampling to determine the levels of drugs and other items found in other locations such as upon various surfaces.

The invention is a method for collecting and analyzing specimens for drugs of abuse and other materials. The invention consists of two major portions, a collection phase and a testing phase. The collection phase may take place in several ways. In one embodiment of the invention, the specimen is obtained by placing an absorptive collection device within a patient's mouth; instructing the patient to chew on said absorptive device for a preselected period of time; allowing the absorptive collection device to remain within a patient's mouth for a preselected period of time; removing the absorptive collection device from said patient's mouth; placing the absorptive collection device within a preselected container; adding a preselected quantity of a buffer solution to said preselected container; centrifuging the collection device and the buffer solution; and removing the absorptive collection device from the preselected container.

In another embodiment of the invention, the specimen is collected by wiping a surface to be tested with an absorptive collection device; placing said absorptive collection device within a preselected container; adding a preselected quantity of a buffer solution to said preselected container; centrifuging said collection device and removing said absorptive collection device from said preselected container.

After the specimen has been collected by either of the aforementioned methods, the samples can be tested by sampling a preselected quantity of material from said container to create a sample; adding a preselected quantity of a preselected reagent to said sample; incubating said reagent and said sample for a preselected period of time; passing a beam of a light having preselected qualities through said sample, said light having a wavelength between 280 and 800 nanometers; measuring the quantity and direction of light that is passed through said sample; adding a second reagent to said sample; passing said beam of light having preselected qualities through said sample, said light having a wavelength between 280 and 800 nanometers; measuring the quantity and direction of light that is passed through the sample; determining the difference between the quantity and direction of light that is passed through the sample after the addition of the second reagent with the quantity and direction of light that is passed through the sample prior to the addition of the second reagent; comparing the difference between the quantity and direction of light that is passed through the sample after the addition of the second reagent with the quantity and direction of light that is passed through the sample prior to the addition of the second reagent, against a pre-calibrated standard.

The purpose of the foregoing Abstract is to enable the public, and especially the scientists, engineers, and practitioners in the art who are not familiar with patent or legal terms or phraseology, to determine quickly from a cursory inspection, the nature and essence of the technical disclosure of the application. The Abstract is neither intended to define the invention, which is measured by the claims, nor is it intended to be limiting as to the scope of the invention in any way

Still other features and advantages of the present invention will become readily apparent to those skilled in this art from the following detailed description describing only the preferred embodiment of the invention, simply by way of illustration of the best mode contemplated by carrying out my invention. As will be realized, the invention is capable of modification in various obvious respects all without departing from the invention. Accordingly, the drawings and description of the preferred embodiment are to be regarded as illustrative in nature, and not as restrictive in nature.

### DESCRIPTION OF THE PREFERRED EMBODIMENTS

While the invention is susceptible of various modifications and alternative constructions, certain illustrated embodiments thereof have been shown in the drawings and will be described below in detail. It should be understood however, that there is no intention to limit the invention to the specific form disclosed, but, on the contrary, the invention is to cover all modifications, alternative constructions, and equivalents falling within the spirit and scope of the invention as defined in the claims.

The present invention is a system and method for extracting, obtaining, collecting, preparing and analyzing oral saliva samples for appropriate quantitative/semi-quantitative levels of drugs of abuse on a light frequency based analyzing instrument. The present invention also includes a specialized and modified needle that allows and facilitates the sampling of materials within the device. While the methods of the present invention are described as being utilized with or in conjunction with a particular embodiment of the invention, it needs to be understood that the invention is not limited thereto, but may be variously embodied according to the various necessities of a user.

In the first embodiment of the invention, a saliva sample is collected by providing the party from whom the specimen is to be collected, a collection device. This collection device typically contains two parts, a swab or absorptive portion and a collection portion into which the swab or absorptive portion fits. Preferably this smaller collection portion is configured to fit within a centrifuge. An example of the type of collection device that is used in the present invention, is a device sold under the trademark SALIVETTE® by (Sarstedt, Leicester, UK).

To collect the sample, the individual from whom the sample is to be collected chews on this absorbent pad for a period of about 30 seconds to one minute and then allows this device to remain in their mouth, saturating with saliva for an additional one to three minutes. After this has taken place, the absorptive sample is then placed in the collection device. Upon placement of the absorptive sample into the collection device, one quantity, preferably one-half milliliter (up to five milliliters) of an oral fluid saliva buffer, such as the Oral Fluid Saliva Buffer sold by LIN-ZHI INTERNATIONAL, INC., is added to the collection device, which already contains the pad. This collection device containing the buffer and the absorptive pad is then centrifuged at 2000 to 4000 rpm for approximately 2 minutes. Once this has been done, the absorptive pad is removed and the remaining liquid poured off and put into a testing cup to be run in the analyzing device. In the preferred embodiment of the invention, this sample size is between 3 microliters and 2 milliliters, and reagent quantities are typically between 50 microliters and 2 milliliters of both reagent 1 and reagent 2.

Depending upon the drugs to be tested, various modifications of this basic methodology must also be employed. For example, in the event that the individual wishes to test for the quantitative/semi-quantitative amounts of Tetrahydrocannabinol or THC (the active ingredient in marijuana) in a particular sample, additional steps must be taken. After the saliva buffer and absorptive swab have been spun, the absorptive pad is then removed and put into a separate container. In this separate container, an amount of an oral fluid THC buffer, such as the Oral Fluid EIA THC Recovery Buffer, which is sold by LIN-ZHI INTERNATIONAL INC equal to the amount of liquid that was expressed from the swab, is added to the container. Once this material has been added, the container sits for a period of time of between one (1) to five (5) minutes. After the incubation time has passed, the cotton swab is then squeezed so as to remove a sufficient sample of material to perform the THC testing on an analyzer as described above. Variations of amounts of sample and reagents one and two may be used to give different sensitivity levels of THC or any of the other drug that are being tested.

In another modification in a situation where the client simply wishes the testing to be sampled for THC and all other relevant drugs of abuse testing, the client places the collection portion of the collection device into their mouth for approximately 30 seconds and then allows the saliva to soak into the device for approximately 1 minute. After this takes place, the item is removed from the patient's mouth and added to a collection device together with equal portions of oral fluid EIA THC or other relevant drugs of abuse recovery buffer. This device is then allowed to incubate for 10 minutes, at the end of this 10 minutes, the saliva is spun at 1500 to 4000 rpm for 1 to 3 minutes. After the end of the spinning, the cotton piece is removed and the aliquot is removed from the extracted sample, poured into the sample cup and is ready for testing as explained in the above.

In addition to the information listed above, it is to be distinctly understood that this same methodology and same reagents may also be utilized in conjunction with testing samples from surfaces to determine the quantity or semi-quantity of drugs in a particular location such as the surfaces on a car door, steering wheel, building walls, countertops, clothing, skin or other surfaces.

In the prior art, the determination by an individual as to whether or not the drugs or other materials were present in a location was determined by utilizing a kit which had test papers located within dispensers. The testing was done by removing the testing papers from the containers and wiping the suspected areas, spraying the test paper with a spray reagent and then viewing the test paper to determine whether or not various substances were present upon the paper itself.

The present invention not only allows a party to determine the presence of a certain drug abuse upon a surface, but also allows a quantitative/semi-quantitative determination of the quantity of these drugs of abuse to be determined. This is very important to individuals such as law officers, parole officers, federal officers and the persons in the department of corrections so that they can determine the quantity of drugs in a particular location, thus allowing them to act appropriately in a particular situation.

The present embodiment simply allows an individual to take a collecting device such as a swab and run this collection device over a desired area such as a wall or counter surface, clothing, skin or other location. This collection device can then be sent to the lab where the device is washed with the buffer solution, allowed to incubate, and tested according to the designated protocol for the particular drugs. This methodology allows the quantitative/semi-quantitative detection of drugs located in a particular place in a way that is not currently available in the prior art.

The testing of the device takes place when these samples are placed into an analyzer that takes a measured amount of sample and a measured amount of reagent 1 and 2, incubates this material and measures the light refraction or absorption in the wavelengths from 280 to 800 nanometers. This testing can be done on automated instrumentation on a variety of types of devices. Examples of such devices include the device sold under the name HITACHI 717, as well as other types of chemistry analyzers or other similar types of analyzing equipment. A line of reagent products such as Oral Fluid EIA reagent sold by Lin-ZHI-International, or similar regents may be utilized to coordinate and run these samples.

In many embodiments of the invention, a reaction between the sample and reagent 1 occurs and a reading of light passing through the sample at a particular wavelength is taken. After this takes place, a second reagent, reagent 2 may then be added. When this takes place, a second reaction occurs and a second measuring of the light at a particular wavelength may be taken.

Depending upon the particular test or assay that is being taken at that particular time, the exact timing of the addition of reagents and the exact identity of these particular reagents may be modified. Furthermore, while the preferred reading of the sample occurs between 340 and 450 nanometers, it is to be distinctly understood that this reading may take place anywhere between 280 and 800 nanometers for optimum sensitivity, but that other wavelengths will work as well. After the samples have been read, the readings are compared to standard, which enables the quantity of the drug material within the sample to be ascertained.

An example of the use of this inventive method to test for the presence of methamphetimine is described below. While the following example is provided, it is to be distinctly understood that the invention is not limited thereto, but may be variously adapted for use with a variety of substances and types of materials.

In one example of the practice of the invention, a saliva sample is collected through a method involving the following steps. First, the party from whom the specimen is to be collected, places a collection device in their mouth. In the preferred embodiment, the collection device is an absorptive pad (preferably made from cotton or another absorptive type of material) that is configured to be placed within in a cup and spun within a centrifuge. An example of the type of collection device used in the present method are those sampling devices sold under the trademark SALIVETTE® sold by Sarstedt, Leicester, UK. These collection devices include a swab portion that is made from absorptive material and a collection container into which the absorptive material can be placed.

The individual chews on the absorptive pad for a period of about 30 seconds to one minute and then allows this device to remain in their mouth absorbing saliva for an additional period of time. After this has period of time has passed, the soaked absorptive pad is removed from the patient's mouth and placed in the collection device. Upon placement of the absorptive sample into the collection device, a quantity of an oral fluid saliva buffer is added to the collection device, which already contains the pad. This collection device containing the buffer and the absorptive pad is then centrifuged at a predesignated rate for a preselected period of time. Once the centrifugation has ended, the absorptive pad is removed and the remaining liquid poured off and put into a testing cup.

After the sample is then placed into a testing cup, the sample is placed upon an analyzing device where the sample is “run” or analyzed according to a designated protocol to determine the quantity of various items within the device. The processing of the sample to obtain a measurement of a designated substance or substances within the sample includes the steps of: dispensing a preselected volume of sample, mixing this preselected volume of sample with a reagent, incubating the sample and a first reagent, adding the second reagent and then either incubating the sample again or reading of the sample and reagent 1 and 2. The reading of the sample is performed by a device that measures the difference of light refracted or absorbed by the sample comparing this refraction or absorption to a known reference material so as to report a result.

While the aforementioned example of the invention has been given, it is to be distinctly understood that the invention is not limited thereto, but may be variously configured and embodied according to the particular necessities of the user. In one embodiment of the invention, the practice of the method is best accomplished by the use of a specifically modified replacement sample pipettor plunger that is configured for insertion within and use upon an automated chemistry analyzer. While the preferred embodiments of the invention is described as being used within a Roche Hitachi 717 automated chemistry analyzer, it is to be distinctly understood that the invention is not limited thereto, but may be variously embodied according to the various needs and necessities of a user.

When used with the Hitachi 717 automated chemistry analyzer, a pipettor plunger style syringe configured to fit within a syringe assembly of an automated chemistry analyzer is used. This device is made up of a head and a shaft. In the preferred embodiment of the invention, the head is made up of an upper plate that has a diameter of about 0.233 inches and a thickness of about 0.088 inches. A drive mechanism adapter portion that is configured to have a diameter of about 0.119 inches and thickness of about 0.168 inches, and a lower plate having a diameter of about 0.233 inches and a thickness of about 0.028 inches. The shaft has a diameter of about 0.0778 inches and an overall length of about 3.529 inches. The shaft is configured to pass completely through the head of the device, thus leaving an exposed shaft portion of about 3.185 inches in length. The aforementioned dimensions are the preferred embodiment only and variation with 0.02 of an inch is contemplated as a part of the invention.

Furthermore, in as much as the dimensions of the present invention are configured for the Hitachi 717 analyzer, it is to be strictly understood that the invention may be variously embodied according to the needs and dimensions of other automated chemistry analyzers.

The sample pipettor plunger is utilized by placing the head of the pipette plunger within the sampling syringe drive mechanism of the automated chemistry analyzer. This drive mechanism enables the pipette plunger to be moved for the purposes of taking and later expelling a sample. The sample pipettor plunger is located within a sample syringe assembly that is connected to the sample probe by a length of tubing.

In use, a sampling probe takes a sample from a sample cup by placing the sample probe into the sample cup. Once this sampling probe is in place within the sample cup by the instrument, the sample pipettor plunger (a movable plunger within the sample syringe assembly) is moved a particular distance by the syringe drive mechanism. When this takes place, a volume of patient sample equal to the volume that the pipette plunger, displaces when being moved in the sample syringe assembly, is then drawn into the sample probe. The automated chemistry analyzer is then removed from the sample cup and placed within a measuring cuvette. When the probe is in the measuring cuvette, the sample syringe drive mechanism moves in the opposite direction and the sample pipette plunger returns back to its starting position and the predetermined sample volume is expelled into the measuring cuvette.

Calibration of the movement of the pipettor plunger within the syringe allows for the variation and modification of the quantity of sample, which can be removed from a particular sample cup. The present invention allows for repeatable sample acquisitions of samples ranging from 1 micro-liter to 2 milliliters depending upon the necessities of the user of the particular test.

While there is shown and described the present preferred embodiment of the invention, it is to be distinctly understood that this invention is not limited thereto, but may be variously embodied to practice within the scope of the following claims. From the foregoing description, it will be apparent that various changes may be made without departing from the spirit and scope of the invention as defined by the following claims.

We claim:

1. A method for obtaining samples for quantitative/semi-quantitative determinations of drugs of abuse within the system of a patient, said method comprising the steps of:
placing an absorptive collection device within a patient's mouth;
instructing said patient to chew on said absorptive device for a preselected period of time;
allowing said absorptive collection device to remain within a patient's mouth for a preselected period of time;
removing said absorptive collection device from said patient's mouth;
placing said absorptive collection device within a preselected container;
adding a preselected quantity of a buffer solution to said preselected container;
centrifuging said collection device and said buffer solution; and
removing said absorptive collection device from said preselected container.

2. A method for obtaining a sample for quantitative/semi-quantitative drug testing from a surface, said method comprising the steps of:
wiping a surface to be tested with an absorptive collection device;
placing said absorptive collection device within a preselected container;
adding a preselected quantity of a buffer solution to said preselected container;
centrifuging said collection device; and
removing said absorptive collection device from said preselected container.

3. A method for determining the presence and quantity of drugs of abuse from a saliva specimen, said method comprising the steps of:
placing an absorptive collection device within a patient's mouth;
instructing said patient to chew on said absorptive device for a preselected period of time;
allowing said absorptive collection device to remain within a patient's mouth for a preselected period of time;
removing said absorptive collection device from said patient's mouth;
placing said absorptive collection device within a preselected container;
adding a preselected quantity of a buffer solution;
centrifuging said collection device and said buffer solution;
removing said absorptive collection device from said container;
sampling a preselected quantity of material from said container, to create a sample;
adding a preselected quantity of a preselected reagent to said sample;
incubating said reagent and said sample for a preselected period of time;
passing a beam of a light having preselected qualities through said sample, said light having a wavelength between 280 and 800 nanometers;
measuring the quantity and direction of light that is passed through said sample;
adding a second reagent to said sample;
passing said beam of light having preselected qualities through said sample, said light having a wavelength between 280 and 800 nanometers;
measuring the quantity and direction of light that is passed through the sample;
determining the difference between the quantity and direction of light that is passed through the sample after the addition of the second reagent with the quantity and direction of light that is passed through the sample prior to the addition of the second reagent;
comparing the difference between the quantity and direction of light that is passed through the sample after the addition of the second reagent with the quantity and direction of light that is passed through the sample prior to the addition of the second reagent, against a pre-calibrated standard.

4. A method for determining the quantity of drugs of abuse upon a surface comprising the steps of:
wiping a surface with an absorptive collection device;
placing said absorptive collection device within a preselected container;
adding a preselected quantity of a buffer solution;
centrifuging said collection device and said buffer solution;
removing said absorptive collection device from said container;
sampling a preselected quantity of material from said container, to create a sample;
adding a preselected quantity of a preselected reagent to said sample;
incubating said reagent and said sample for a preselected period of time;
passing a beam of a light having preselected qualities through said sample, said light having a wavelength between 280 and 800 nanometers;
measuring the quantity and direction of light that is passed through said sample;
adding a second reagent to said sample;
passing said beam of light having preselected qualities through said sample, said light having a wavelength between 280 and 800 nanometers;
measuring the quantity and direction of light that is passed through the sample;
determining the difference between the quantity and direction of light that is passed through the sample after the addition of the second reagent with the quantity and direction of light that is passed through the sample prior to the addition of the second reagent;
comparing the difference between the quantity and direction of light that is passed through the sample after the addition of the second reagent with the quantity and direction of light that is passed through the sample prior to the addition of the second reagent, against a pre-calibrated standard.
